(19) United States
(12) Patent Application Publication
(10) Pub. No.: US 2021/0095841 A1
(43) Pub. Date: Apr. 1, 2021

(54) Antenna Assemblies For Light Fixtures

(71) Applicant: SIGNIFY HOLDING B.V., EINDHOVEN (NL)

(72) Inventor: Ajinkya C. Kulkarni, Dhule (IN)

(21) Appl. No.: 16/585,713

(22) Filed: Sep. 27, 2019

(51) Int. Cl. F21V 23/04; H01Q 1/22

(52) U.S. Cl. CPC F21V 23/045; F21Y 2115/10; H01Q 1/22

(57) ABSTRACT

A light fixture disposed in an ambient environment can include a first plurality of light sources, and a first circuit board on which the first plurality of light sources is mounted. The light fixture can also include a first antenna assembly coupled to the first circuit board, where the first antenna assembly includes a first base and a first antenna mounted on the first base, where the first base has a first portion, a second portion, and a third portion, where the first antenna and the first portion of the first base are disposed within a first aperture of the first circuit board, where the second portion of the first base is coupled to the first circuit board at a first location, and where the third portion of the first base is coupled to the first circuit board at a second location.

### TECHNICAL FIELD

Embodiments described herein relate generally to light fixtures, and more particularly to systems, methods, and devices for antenna assemblies for light fixtures.

### BACKGROUND

In many applications, one or more antennae are used with electrical devices, such as light fixtures, to allow for communication with other electrical devices as part of an integrated system. With light fixtures, antennae can often affect the performance of those light fixtures. For example, an antenna can be positioned in such a way as to create shadowing with respect to the light output by a light fixture.

### SUMMARY

In general, in one aspect, the disclosure relates to a light fixture disposed in an ambient environment. The light fixture can include a first plurality of light sources and a first circuit board on which the first plurality of light sources is mounted. The light fixture can also include a first antenna assembly coupled to the first circuit board, where the first antenna assembly includes a first base and a first antenna mounted on the first base, where the first base has a first portion, a second portion, and a third portion, where the first antenna and the first portion of the first base are disposed within a first aperture of the first circuit board, where the second portion of the first base is coupled to the first circuit board at a first location, and where the third portion of the first base is coupled to the first circuit board at a second location.

In another aspect, the disclosure can generally relate to an antenna assembly for a light fixture. The antenna assembly can include a base having a first portion, a second portion, and a third portion. The antenna assembly can also include an antenna mounted on the first portion of the base, where the antenna and the first portion of the base are configured to be disposed within an aperture that traverses a circuit board of the light fixture, where the second portion of the base is configured to be coupled to the circuit board of the light fixture at a first location adjacent to the aperture, where the third portion of the base is configured to be coupled to the circuit board of the light fixture at a second location adjacent to the aperture, and where the antenna is communicably coupled to a controller of the light fixture.

These and other aspects, objects, features, and embodiments will be apparent from the following description and the appended claims.

### BRIEF DESCRIPTION OF THE DRAWINGS

The drawings illustrate only example embodiments of antenna assemblies for light fixtures and are therefore not to be considered limiting of its scope, as antenna assemblies for light fixtures may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, reference numerals designate like or corresponding, but not necessarily identical, elements.

FIG. 1 shows a diagram of a lighting system that includes a light fixture in accordance with certain example embodiments.

FIG. 2 shows a computing device in accordance with certain example embodiments.

FIG. 3 shows a cross-sectional top-side perspective view of a light fixture with an antenna assembly currently used in the art.

FIG. 4 shows a graph of shadow effects created by the antenna assembly of FIG. 3.

FIGS. 5A and 5B show a light fixture with an antenna assembly in accordance with certain example embodiments.

FIG. 6 shows a graph of the impedance of the antenna assembly of FIGS. 5A and 5B.

FIG. 7 shows a graph of the omni-directional radiation pattern for the antenna assembly of FIGS. 5A and 5B.

FIG. 8 shows a graph of the gain of the antenna assembly of FIGS. 5A and 5B.

FIG. 9 shows a graph of the return loss of the antenna assembly of FIGS. 5A and 5B.

FIGS. 10A and 10B show a light fixture subassembly that includes an antenna assembly in accordance with certain example embodiments.

FIGS. 11A and 11B show another light fixture subassembly that includes multiple antenna assemblies in accordance with certain example embodiments.

### DETAILED DESCRIPTION OF EXAMPLE EMBODIMENTS

The example embodiments discussed herein are directed to systems, methods, and devices for antenna assemblies for light fixtures. While example embodiments are described herein as being used with light fixtures, example embodiments can be used with any other type of electrical device that includes a light source and/or a circuit board. Examples of such other types of electrical devices can include, but are not limited to, a control panel with a display, a ceiling fan, a sensor device, a digital clock, a sensor device, and a television. Further, antennae from example antenna assemblies can communicate using any of a number of different technologies and/or protocols. Such other technologies and protocols can include, but are not limited, to WiFi, Bluetooth, Bluetooth Low Energy (BLE), Zigbee, radio frequency waves, ultraviolet waves, microwaves, and infrared signals.

Example embodiments can be used for a volume of space having any size and/or located in any environment (e.g., indoor, outdoor, hazardous, non-hazardous, high humidity, low temperature, corrosive, sterile, high vibration). Light fixtures described herein can use one or more of a number of different types of light sources, including but not limited to light-emitting diode (LED) light sources, fluorescent light sources, organic LED light sources, incandescent light sources, and halogen light sources. Therefore, light fixtures described herein, even in hazardous locations, should not be considered limited to a particular type of light source. When light sources of a light fixture use LED technology, one or more of any type of LED technology can be included, such as chip-on-board, discrete, arrays, and multicolor.

Further, a light source with which example antenna assemblies can be used can be any of a number of types of light fixtures. Examples of such types of light fixtures can include, but are not limited to, a down can light, a pendant light, a street light, a Hi-Bay light, a floodlight, a beacon, a desk lamp, an emergency egress light, and a light integrated with a ceiling fan. In certain example embodiments, light fixtures (or other devices) that include example antenna assemblies are subject to meeting certain standards and/or requirements. For example, the National Electric Code (NEC), Underwriters Laboratory (UL), the National Electrical Manufacturers Association (NEMA), the International Electrotechnical Commission (IEC), the Federal Communication Commission (FCC), and the Institute of Electrical and Electronics Engineers (IEEE) set standards as to electrical enclosures (e.g., light fixtures), wiring, and electrical connections. Use of example embodiments described herein meet (and/or allow a corresponding device to meet) such standards when required.

If a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of antenna assemblies for light fixtures will be described more fully hereinafter with reference to the accompanying drawings, in which example embodiments of antenna assemblies for light fixtures are shown. Antenna assemblies for light fixtures may, however, be embodied in many different forms and should not be construed as limited to the example embodiments set forth herein. Rather, these example embodiments are provided so that this disclosure will be thorough and complete, and will fully convey the scope of antenna assemblies for light fixtures to those of ordinary skill in the art. Like, but not necessarily the same, elements (also sometimes called components) in the various figures are denoted by like reference numerals for consistency.

Terms such as “first”, “second”, “on”, “upon”, “outer”, “inner”, “front”, “rear”, “top”, “bottom”, and “within” are used merely to distinguish one component (or part of a component or state of a component) from another. Such terms are not meant to denote a preference or a particular orientation. Such terms are not meant to limit embodiments of antenna assemblies for light fixtures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

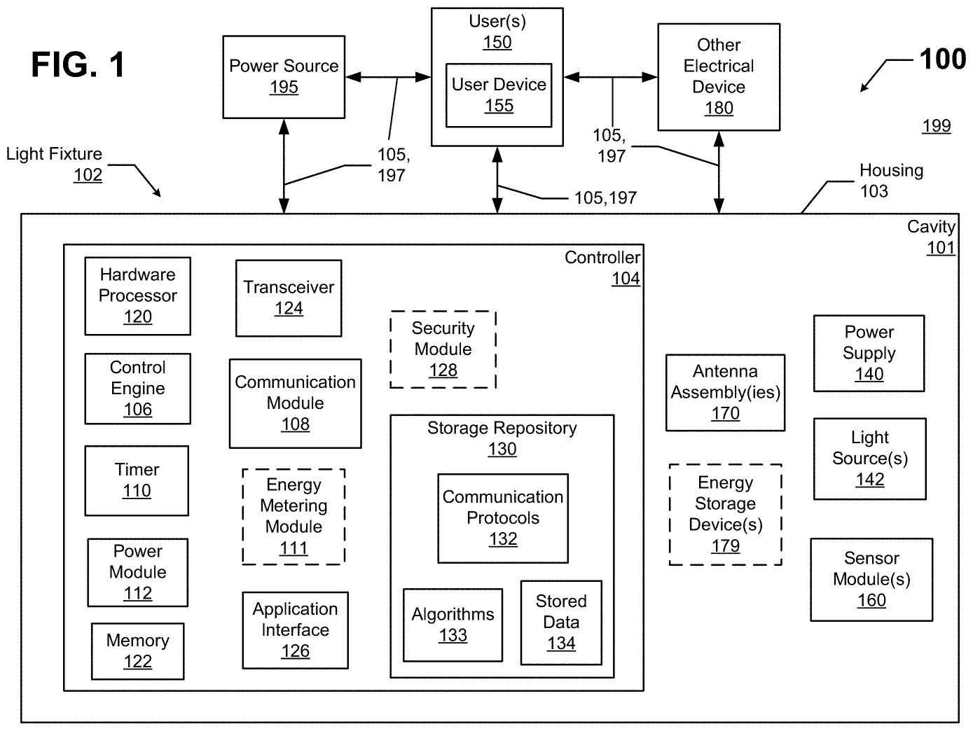

FIG. 1 shows a system diagram of a lighting system 100 in a volume of space 199 that includes an antenna assembly 170 for a light fixture 102 in accordance with certain example embodiments. The lighting system 100 can include a power source 195, one or more users 150, one or more other electrical devices 180, and at least one light fixture 102. In addition to the one or more antennae assemblies 170, the light fixture 102 can include a controller 104, one or more optional energy storage devices 179, one or more sensor modules 160, at least one power supply 140, and at least one light source 142.

The controller 104 can include one or more of a number of components. As shown in FIG. 1, such components can include, but are not limited to, a control engine 106, a communication module 108, a timer 110, an optional energy metering module 111, a power module 112, a storage repository 130, a hardware processor 120, a memory 122, a transceiver 124, an application interface 126, and, optionally, a security module 128. The components shown in FIG. 1 are not exhaustive, and in some embodiments, one or more of the components shown in FIG. 1 may not be included in an example light fixture. Any component of the example light fixture 102 can be discrete or combined with one or more other components of the light fixture 102.

As discussed above, the volume of space 199 can be indoors or outdoors. The volume of space 199 can be well defined (e.g., walls, ceiling, floor) and/or unbounded. In an unbounded case, a volume of space 199 can be somewhat limited by some other factor, such as the communication range of a sensor module 160 and/or an antenna assembly 170. The volume of space 199 can be located in one or more of any type of environment, including but not limited to hot, cold, humid, wet, dry, climate-controlled, sterile, and windowless.

A user 150 can be any person that interacts with light fixtures (or components thereof (e.g., an antenna assembly 170, a sensor module 160)). Examples of a user 150 may include, but are not limited to, an occupant in the volume of space 199, an engineer, an electrician, an instrumentation and controls technician, a mechanic, an operator, a consultant, an inventory management system, an inventory manager, a foreman, a labor scheduling system, a contractor, and a manufacturer's representative.

A user 150 can use a user device 155 (also sometimes called a user system 155), which may include a display (e.g., a GUI). A user 150 (which can include an associated user system 155) interacts with (e.g., sends data to, receives data from) the controller 104 of the light fixture 102 using the example antenna assembly 170 (described below) of the light fixture 102. A user 150 (which can include an associated user system 155) can also interact with one or more of the other electrical devices 180. In either case, a user 150 can include a user device (not shown), which can be a type of other electrical device 180 for sending communication signals 197 to and/or receiving communication signals 197 from the light fixture 102 using the antenna assembly 170. A communication signal 197 (also sometimes referred to herein as simply a signal 197) can be any type of signal, including but not limited to a radio frequency (RF) signal. A communication signal 197 can include an identification value, a command, data, information, and/or other content.

Interaction (e.g., communication signals 197) between a user system of a user 150, the light fixture 102, one or more of the other electrical devices 180, and the power source 195 is conducted using communication links 105. Each communication link 105 can include wired (e.g., Class 1 electrical cables, Class 2 electrical cables, electrical connectors, power line carrier, DALI, RS485) and/or wireless (e.g., Wi-Fi, visible light communication, cellular networking, Bluetooth, Bluetooth Low Energy (BLE), WirelessHART, ISA100) technology. For example, a communication link 105 can be (or include) one or more electrical conductors that are coupled to the housing 103 of the light fixture 102 and to a sensor module 160. A communication link 105 can transmit signals (e.g., power signals, communication signals 197) between the light fixture 102, a user system 155 of a user 150, one or more of the other electrical devices 180, and the power source 195.

The other electrical devices 180 can be any type of device that communicates, directly or indirectly, with the light fixture 102 in the system 100. For example, one of the other electrical devices 180 can be another light fixture. As another example, one of the other electrical devices 180 can be a network manager (also sometimes called a gateway or a master controller). A network manager is a device or component that controls all or a portion of a communication network that includes the controller 104 of the light fixture 102 and the other electrical devices 180. The network manager can be substantially similar to the controller 104, but on a system level rather than just the light fixture 102. The network manager can include one or more of a number of features in addition to, or altered from, the features of the controller 104 described below. As described herein, communication with the network manager can include communicating with one or more other components (e.g., the light fixture 102, a user device 155, one or more of the other electrical devices 180) of the system 100.

The power source 195 of the system 100 provides AC mains or some other form of power to the light fixture 102, as well as to one or more other components (e.g., one or more of the other electrical devices 180) of the system 100. The power source 195 can include one or more of a number of components. Examples of such components can include, but are not limited to, an electrical conductor, a coupling feature (e.g., an electrical connector), a transformer, an inductor, a resistor, a capacitor, a diode, a transistor, and a fuse. The power source 195 can be, or include, for example, a wall outlet, an energy storage device (e.g. a battery, a supercapacitor), a circuit breaker, and/or an independent source of generation (e.g., a photovoltaic solar generation system). The power source 195 can also include one or more components (e.g., a switch, a relay, a controller) that allow the power source 195 to communicate with and/or follow instructions from a user 150 (including an associated user device 155), the controller 104 of the light fixture 102, and/or one or more of the other electrical devices 180.

As discussed above, the light fixture of FIG. 1 includes the controller 104, an optional energy storage device 179, the antenna assembly 170, a power supply 140, one or more light sources 142, and one or more sensor modules 160. The optional energy storage device 179 can be any of a number of rechargeable batteries or similar storage devices that are configured to charge using some source of power (e.g., the power provided to the light fixture 102 by the power source 195, ultraviolet rays). The energy storage device 179 can use one or more of any type of storage technology, including but not limited to a battery, a flywheel, an ultracapacitor, and a supercapacitor.

If the energy storage device 179 includes a battery, the battery technology can vary, including but not limited to lithium ion, nickel-cadmium, lead/acid, solid state, graphite anode, titanium dioxide, nickel cadmium, nickel metal hydride, nickel iron, alkaline, and lithium polymer. In some cases, one or more of the energy storage devices 179 charge using a different level and/or type of power relative to the level and type of power of the primary power. In such a case, the power supply 179 can convert, invert, transform, and/or otherwise manipulate the primary power to the level and type of power used to charge the energy storage devices 179. There can be any number of energy storage devices 179.

The antenna assembly 170 can be any assembly of components that is used to improve the ability of the light fixture 102 (or portion thereof, such as the transceiver 124 or a sensor module 160) to send and/or receive communication signals 197 with one or more of the other electrical devices 180, the power source 195, a user 150 (including an associated user device 155), and/or some other device within the system 100. The antenna assembly 170 can be used to convert electrical power into radio waves and/or convert radio waves into electrical power. An antenna assembly 170 can be used with a single component (e.g., the controller 104) of the light fixture 102. Alternatively, an antenna assembly 170 can be used with multiple components (e.g., a sensor module 160, the controller 104) of the light fixture 102.

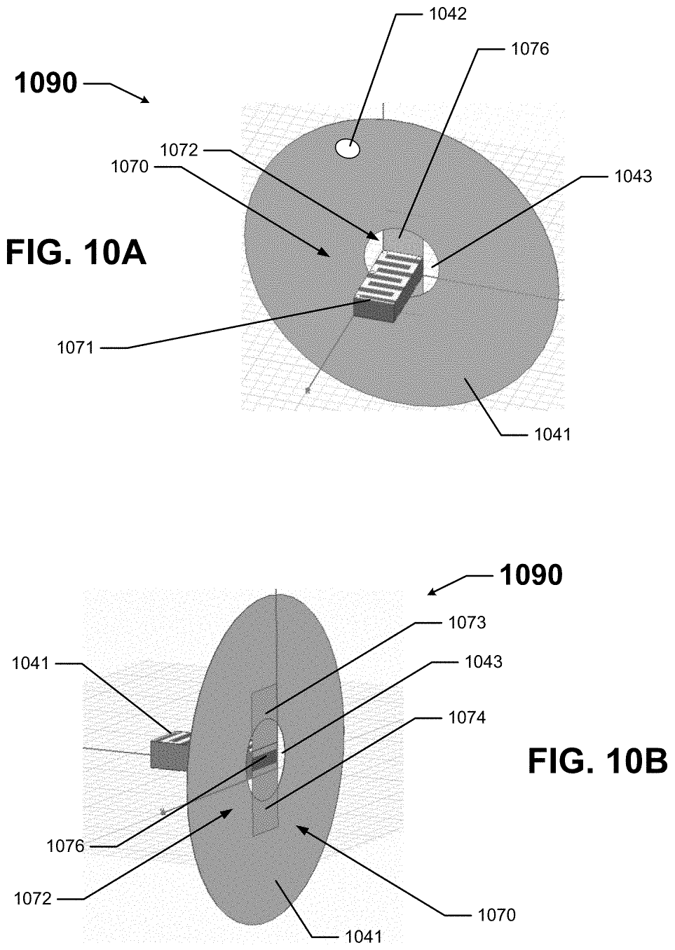

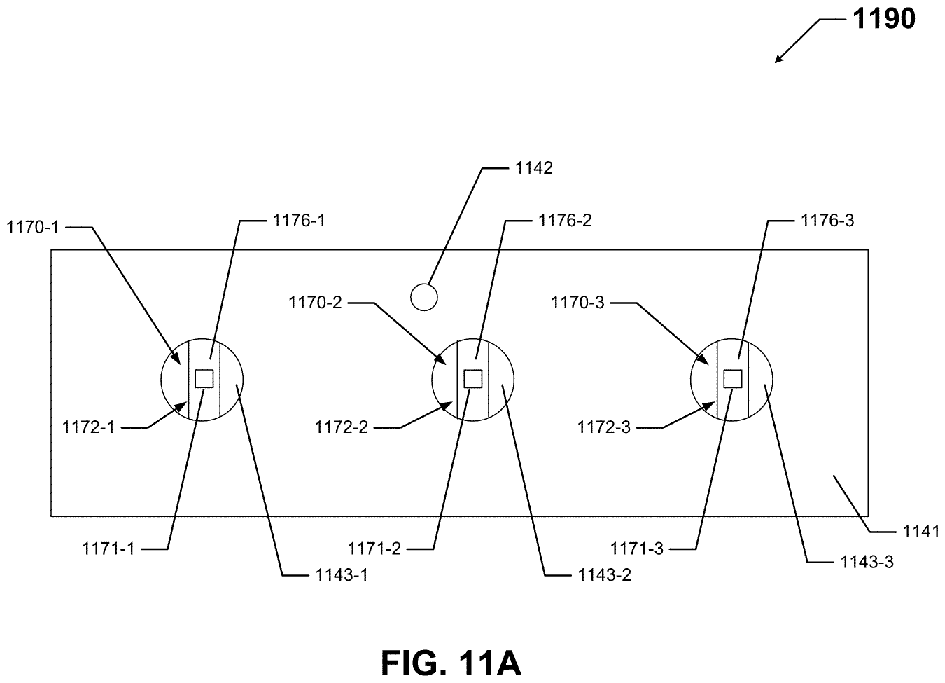

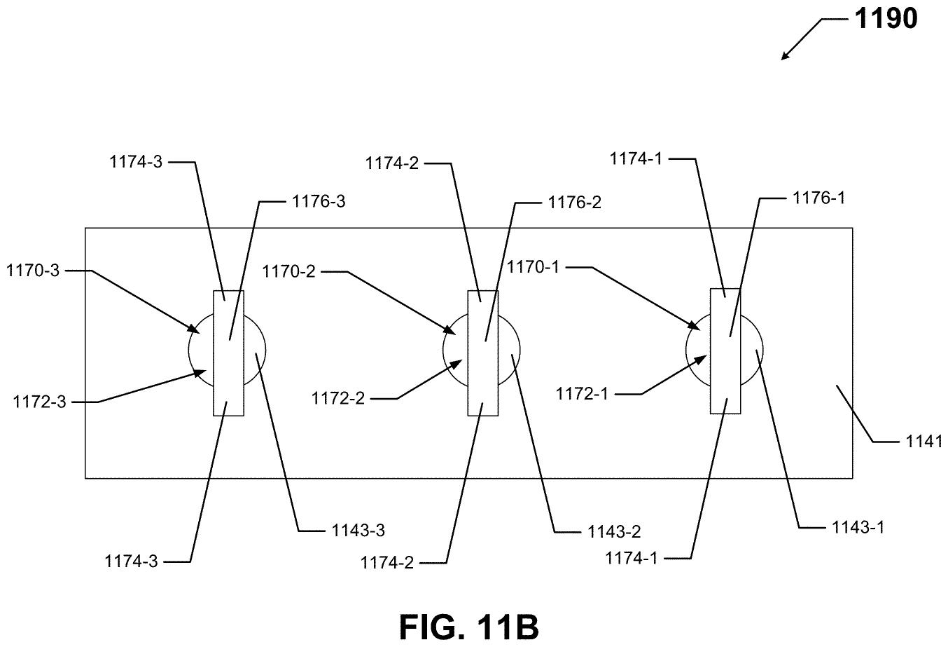

The antenna assembly 170 in example embodiments can be at least partially disposed within the housing 103 of the light fixture 102. For example, as shown in FIGS. 10A through 11B below, the antenna assembly 170 can be disposed on a circuit board used for the light sources 142 within the housing 103 of the light fixture 102. Specifically, the antenna assembly 170 can be integrated with or coupled to the circuit board of the light sources 142 (discussed below). In alternative embodiments, some or all of the antenna assembly 170 can be disposed on (e.g., integrated with, coupled to) the housing 103 of the light fixture 102 and/or extend away from the housing 103 in the ambient environment of the volume of space 199. Example antenna assemblies 170 (or portions thereof) described herein can be printed on a portion (e.g., a circuit board of the light sources 142) of the light fixture 102, adhered to a portion of the light fixture 102, and/or otherwise coupled to a portion of the light fixture 102.

In certain example embodiments, the antenna assembly 170 includes one or more of a number of components. Such components can include, but are not limited to, one or more antennae, a base, a receiver, a transmitter, a balun, a block upconverter, a cable (e.g., a coaxial cable or other form of communication link 105), a counterpoise (a type of ground system), a feed, a passive radiator, a feed line, a rotator, a tuner, a low-noise block downconverter, and a twin lead. Portions of the antenna assembly 170 can be in direct communication with, or can be shared with, one or more components (e.g., the communications module 108, the transceiver 124) of the controller 104. For example, the transceiver 124 of the controller 104 can be in direct communication with the antenna assembly 170.

A base of an antenna assembly 170 can be a type of substrate on which the antenna is disposed or mounted. The base can be constructed from one or more of any of a number of materials, including but not limited to FR4, MCPCB (metal core pcb), flex circuit, and TFPCB (thick film pcb). When the base is FR4 or some other similar type of fiberglass composite, the thickness of the base can be small (e.g., less than 2 mm) while allowing for high durability of the base. Examples of a base and antenna of an antenna assembly 170 is shown and described below with respect to FIGS. 10A through 11B.

The one or more sensor modules 160 can include any type of sensing device that measure one or more parameters. Examples of types of sensor modules 160 can include, but are not limited to, a passive infrared sensor, a photocell, a pressure sensor, an air flow monitor, a gas detector, and a resistance temperature detector. A parameter that can be measured by a sensor module 160 can include, but is not limited to, occupancy, motion, an amount of ambient light, temperature within the housing 103 of the light fixture 102, humidity within the housing 103 of the light fixture 102, air quality within the housing 103 of the light fixture 102, vibration, pressure, air flow, smoke (as from a fire), temperature (e.g., excessive heat, excessive cold, an ambient temperature) outside the housing 103 of the light fixture 102. A measurement made by a sensor module 160 can be sent, using the antenna assembly 170, to one or more other components (e.g., one of the other electrical devices 180) in the system 100.

In some cases, the parameter or parameters measured by a sensor module 160 can be used to operate one or more light sources 142 of the light fixture 102. Each sensor module 160 can use one or more of a number of communication protocols to receive commands, send measurements, and/or otherwise communicate with the controller 104 and/or another component of the system 100. A sensor module 160 can be associated with the light fixture 102 and/or one or more other electrical devices 180 in the system 100. A sensor module 160 can be located within the housing 103 of the light fixture 102, disposed on the housing 103 of the light fixture 102, or located outside the housing 103 of the light fixture 102.

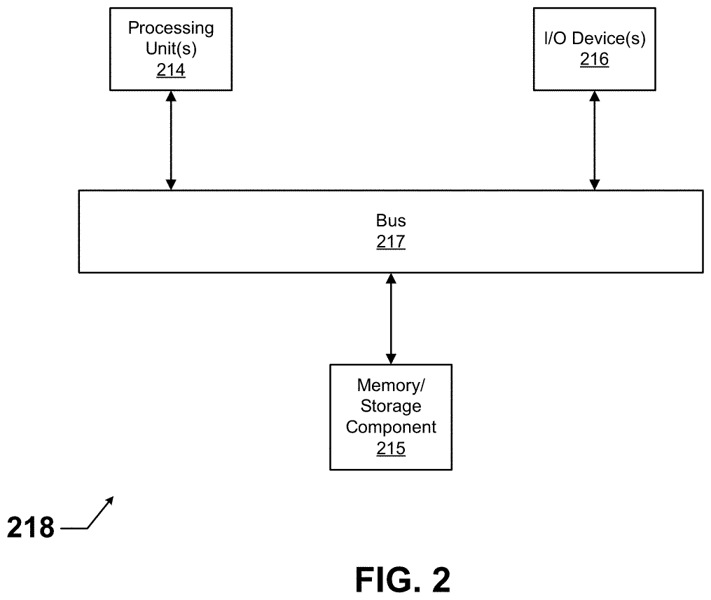

In certain example embodiments, a sensor module 160 can include an energy storage device (e.g., a battery) that is used to provide power, at least in part, to some or all of the sensor module 160. In such a case, the energy storage device can be the same as, or independent of, the energy storage device 179, described above, of the light fixture 102. The energy storage device of the sensor module 160 can operate at all times or when a primary source of power to the light fixture 102 is interrupted. Further, a sensor module 160 can utilize or include one or more components (e.g., memory 122, storage repository 130, transceiver 124) found in the controller 104. In such a case, the controller 104 can provide the functionality of these components used by the sensor module 160. Alternatively, the sensor module 160 can include, either on its own or in shared responsibility with the controller 104, one or more of the components of the controller 104. In such a case, the sensor module 160 can correspond to a computer system as described below with regard to FIG. 2.

A user 150 (including an associated user device 155), the other electrical devices 180, and/or the power source 195 can interact with the controller 104 of the light fixture 102 using the application interface 126 via the antenna assembly 170 in accordance with one or more example embodiments. Specifically, the application interface 126 via the antenna assembly 170 of the controller 104 receives data (e.g., information, communications, instructions, updates to firmware) from and sends data (e.g., information, communications, instructions) to the a 150 (including an associated user device 155), the other electrical devices 180, and/or the power source 195. A user 150 (including an associated user device 155), the other electrical devices 180, and/or the power source 195 can include an interface to receive data from and send data to the controller 104 via the antenna assembly 170 in certain example embodiments. Examples of such an interface can include, but are not limited to, a graphical user interface, a touchscreen, an application programming interface, a keyboard, a monitor, a mouse, a web service, a data protocol adapter, some other hardware and/or software, or any suitable combination thereof.

The controller 104, a user 150 (including an associated user device 155), the other electrical devices 180, and/or the power source 195 can use their own system or share a system in certain example embodiments. Such a system can be, or contain a form of, an Internet-based or an intranet-based computer system that is capable of communicating with various software. A computer system includes any type of computing device and/or communication device, including but not limited to the controller 104. Examples of such a system can include, but are not limited to, a desktop computer with a Local Area Network (LAN), a Wide Area Network (WAN), Internet or intranet access, a laptop computer with LAN, WAN, Internet or intranet access, a smart phone, a server, a server farm, an android device (or equivalent), a tablet, smartphones, and a personal digital assistant (PDA). In all cases, communication signals 179 can be sent and received with respect to the light fixture 102 using the example antenna assembly 170. Such a system can correspond to a computer system as described below with regard to FIG. 2.

Further, as discussed above, such a system can have corresponding software (e.g., user software, controller software, other electrical device software). The software can execute on the same or a separate device (e.g., a server, mainframe, desktop personal computer (PC), laptop, PDA, television, cable box, satellite box, kiosk, telephone, mobile phone, or other computing devices) and can be coupled by the communication network (e.g., Internet, Intranet, Extranet, LAN, WAN, or other network communication methods) and/or communication channels, with wire and/or wireless segments according to some example embodiments. The software of one system can be a part of, or operate separately but in conjunction with, the software of another system within the system 100.

As discussed above, the light fixture 102 can include a housing 103. The housing 103 can include at least one wall that forms a cavity 101. In some cases, the housing can be designed to comply with any applicable standards so that the light fixture 102 can be located in a particular environment (e.g., outdoors, in an indoor “clean room”) or volume of space 199.

The housing 103 of the light fixture 102 can be used to house one or more components of the light fixture 102, including one or more components of the controller 104. For example, as shown in FIG. 1, the controller 104 (which in this case includes the control engine 106, the communication module 108, the timer 110, the optional energy metering module 111, the power module 112, the storage repository 130, the hardware processor 120, the memory 122, the transceiver 124, the application interface 126, and the optional security module 128), one or more of the sensor modules 160, one or more antenna assemblies 170, the power supply 140, the optional energy storage devices 179, and the light sources 142 are disposed in the cavity 101 formed by the housing 103. In alternative embodiments, any one or more of these or other components of the light fixture 102 can be disposed on the housing 103 and/or remotely from the housing 103. For instance, a sensor module 160 (or portion thereof) can be integrated with the housing 103.

The storage repository 130 can be a persistent storage device (or set of devices) that stores software and data used to assist the controller 104 in communicating with a user 150 (including an associated user device 155), the other electrical devices 180, and the power source 195 within the system 100. In one or more example embodiments, the storage repository 130 stores one or more communication protocols 132, one or more algorithms 133, and stored data 134. The protocols 132 can be one or more of any number of procedures (e.g., a series of method steps) and/or other similar operational procedures that the control engine 106 of the controller 104 follows based on certain conditions at a point in time. The communication protocols 132 can be any of a number of protocols that are used to send and/or receive data between the controller 104 and a user 150 (including an associated user device 155), the other electrical devices 180, and the power source 195.

The protocols 132 can include one or more protocols used for communication. One or more of the communication protocols 132 can be a time-synchronized protocol. Examples of such time-synchronized protocols can include, but are not limited to, a highway addressable remote transducer (HART) protocol, a wirelessHART protocol, and an International Society of Automation (ISA) 100 protocol. In this way, one or more of the communication protocols 132 can provide a layer of security to the data transferred within the system 100. Other protocols 132 can be associated with the use of Wi-Fi, Zigbee, visible light communication, cellular networking, BLE, and Bluetooth.

The algorithms 133 can be any models, formulas, and/or other similar operational implementations that the control engine 106 of the controller 104 uses. An algorithm 133 can at times be used in conjunction with a protocol 132. Algorithms 133 and/or protocols 132 can be focused on certain functionality of the light fixture 102. For example, one or more algorithms 133 and/or one or more protocols can be used to facilitate communication between one or more of the other electrical devices 180 and the control engine 106 of the controller 104 using example antenna assemblies 170.

Stored data 134 can be any data associated with the light fixture 102 (including any components thereof), any measurements taken by the sensor modules 160, measurements taken by the energy metering module 111, threshold values, operating and nameplate data associated with an example antenna assembly 170, results of previously run or calculated algorithms 133, and/or any other suitable data. Such data can be any type of data, including but not limited to historical data, current data, and forecasts. The stored data 134 can be associated with some measurement of time derived, for example, from the timer 110.

Examples of a storage repository 130 can include, but are not limited to, a database (or a number of databases), a file system, a hard drive, flash memory, cloud-based storage, some other form of solid state data storage, or any suitable combination thereof. The storage repository 130 can be located on multiple physical machines, each storing all or a portion of the communication protocols 132, the algorithms 133, and/or the stored data 134 according to some example embodiments. Each storage unit or device can be physically located in the same or in a different geographic location.

The storage repository 130 can be operatively connected to the control engine 106. In one or more example embodiments, the control engine 106 includes functionality to communicate with a user 150 (including an associated user device 155), the other electrical devices 180, and the power source 195 in the system 100. More specifically, the control engine 106 sends information to and/or receives information from the storage repository 130 in order to communicate with a user 150 (including an associated user device 155), the other electrical devices 180, and the power source 195. As discussed below, the storage repository 130 can also be operatively connected to the communication module 108 in certain example embodiments.

In certain example embodiments, the control engine 106 of the controller 104 controls the operation of one or more components (e.g., the communication module 108, the timer 110, the transceiver 124) of the controller 104. For example, the control engine 106 can activate the communication module 108 when the communication module 108 is in “sleep” mode and when the communication module 108 is needed to send data received from another component (e.g., a sensor module 160, the user 150) in the system 100.

As another example, the control engine 106 can acquire the current time using the timer 110. The timer 110 can enable the controller 104 to control the light fixture 102 even when the controller 104 has no communication with the other electrical device 180. As yet another example, the control engine 106 can direct the energy metering module 111 to measure and send power consumption information of the light fixture 102 to the other electrical device 180. In some cases, the control engine 106 of the controller 104 can generate and send a dimming signal (e.g., 0-10 V DC) to the power supply 140, which causes the power supply 140 to adjust the light output of the light sources 142.

The control engine 106 of the controller 104 can communicate, in some cases using the antenna assembly 170, with one or more of the sensor modules 160 and make determinations based on measurements made by the sensor modules 160 (which can use example antennae assemblies 170). For example, the control engine 106 can use one or more algorithms 133 to facilitate communication with a sensor module 160. As a specific example, the control engine 160 can use one or more algorithms 133 to instruct a sensor module 160 to measure (in some cases using an antenna assembly 170) a parameter, for the sensor module 160 to send the measurement to the control engine 106, for the control engine 106 to analyze the measurement, (stored as stored data 134) and for the control engine 106 to take an action (e.g., instruct, using a communication protocol 132, one or more other components of the light fixture 102 to operate) based on the result (stored as stored data 134) of the analysis.

The control engine 106 can also use the antenna assembly 170 to send and/or receive communications. As a specific example, the control engine 106 can use one or more algorithms 133 to receive (using a communication protocol 132) a signal received by the antenna assembly 170, for the control engine 106 to analyze the signal, and for the control engine 106 to take an action (e.g., instruct one or more other components of the light fixture 102 to operate) based on the result of the analysis. As another specific example, the control engine 106 can use one or more algorithms 133 to determine that a communication to a device external to the light fixture 102 needs to be sent, and to send a communication signal 197 (using a communication protocol 132 and saved as stored data 134) using the antenna assembly 170.

The control engine 106 can provide, in some cases using an antenna assembly 170, control signals, communication signals 197, and/or other types of signals to a user 150 (including an optional transceiver 198), the other electrical device 180, the power source 195, and one or more of the sensor modules 160. Similarly, the control engine 106 can receive, in some cases using the antenna assembly 170, control signals, communication signals 197, and/or other types of signals from a user 150 (including an optional transceiver 198), the other electrical device 180, the power source 195, and one or more of the sensor modules 160. The control engine 106 can control each sensor module 160 automatically (for example, based on one or more algorithms stored in the control engine 106) and/or based on control signals, communication signals 197, and/or other types of signals received from another device through a communication link 105. The control engine 106 may include a printed circuit board, upon which the hardware processor 120 and/or one or more discrete components of the controller 104 are positioned.

In certain embodiments, the control engine 106 of the controller 104 can communicate, in some cases using the antenna assembly 170, with one or more components of a system external to the system 100. For example, the control engine 106 can interact with an inventory management system by ordering a light fixture (or one or more components thereof) to replace the light fixture 102 (or one or more components thereof) that the control engine 106 has determined to fail or be failing. As another example, the control engine 106 can interact with a workforce scheduling system by scheduling a maintenance crew to repair or replace the light fixture 102 (or portion thereof) when the control engine 106 determines that the light fixture 102 or portion thereof requires maintenance or replacement. In this way, the controller 104 is capable of performing a number of functions beyond what could reasonably be considered a routine task.

In certain example embodiments, the control engine 106 can include an interface that enables the control engine 106 to communicate with one or more components (e.g., power supply 140) of the light fixture 102. For example, if the power supply 140 of the light fixture 102 operates under IEC Standard 62386, then the power supply 140 can have a serial communication interface that will transfer data (e.g., stored data 134) measured by the sensor modules 160. In such a case, the control engine 106 can also include a serial interface to enable communication with the power supply 140 within the light fixture 102. Such an interface can operate in conjunction with, or independently of, the communication protocols 132 used to communicate between the controller 104 and the user 150, the other electrical device 180, the power source 195, and the sensor modules 160.

The control engine 106 (or other components of the controller 104) can also include one or more hardware components and/or software elements to perform its functions. Such components can include, but are not limited to, a universal asynchronous receiver/transmitter (UART), a serial peripheral interface (SPI), a direct-attached capacity (DAC) storage device, an analog-to-digital converter, an inter-integrated circuit (I2C), and a pulse width modulator (PWM).

The communication module 108 of the controller 104 determines and implements the communication protocol (e.g., from the communication protocols 132 of the storage repository 130) that is used when the control engine 106 communicates with (e.g., sends signals to, receives signals from) a user 150 (including an optional transceiver 198), the other electrical device 180, the power source 195, and/or one or more of the sensor modules 160. In some cases, the communication module 108 accesses the stored data 134 to determine which communication protocol is used to communicate with the sensor module 160 associated with the stored data 134. In addition, the communication module 108 can interpret the communication protocol of a communication received by the controller 104 so that the control engine 106 can interpret the communication.

The communication module 108 can send and receive data, in some cases using the antenna assembly 170, between the other electrical device 180, the power source 195, the sensor modules 160, and/or the users 150 (including an optional transceiver 198) and the controller 104. The communication module 108 can send and/or receive data in a given format that follows a particular communication protocol 132. The control engine 106 can interpret the data packet received from the communication module 108 using the communication protocol 132 information stored in the storage repository 130. The control engine 106 can also facilitate the data transfer between one or more sensor modules 160 and the other electrical device 180 or a user 150 by converting the data into a format understood by the communication module 108.

The communication module 108 can send data (e.g., communication protocols 132, algorithms 133, stored data 134, operational information, alarms) directly to and/or retrieve data directly from the storage repository 130. Alternatively, the control engine 106 can facilitate the transfer of data between the communication module 108 and the storage repository 130. The communication module 108 can also provide encryption to data that is sent by the controller 104 and decryption to data that is received by the controller 104. The communication module 108 can also provide one or more of a number of other services with respect to data sent from and received by the controller 104. Such services can include, but are not limited to, data packet routing information and procedures to follow in the event of data interruption.

The timer 110 of the controller 104 can track clock time, intervals of time, an amount of time, and/or any other measure of time. The timer 110 can also count the number of occurrences of an event, whether with or without respect to time. Alternatively, the control engine 106 can perform the counting function. The timer 110 is able to track multiple time measurements concurrently. The timer 110 can track time periods based on an instruction received from the control engine 106, based on an instruction received from the user 150, based on an instruction programmed in the software for the controller 104, based on some other condition or from some other component, or from any combination thereof.

The timer 110 can be configured to track time when there is no power delivered to the controller 104 (e.g., the power module 112 malfunctions) using, for example, a super capacitor or a battery backup. In such a case, when there is a resumption of power delivery to the controller 104, the timer 110 can communicate any aspect of time to the controller 104. In such a case, the timer 110 can include one or more of a number of components (e.g., a super capacitor, an integrated circuit) to perform these functions.

The energy metering module 111 of the controller 104 measures one or more components of power (e.g., current, voltage, resistance, VARs, watts) at one or more points within the light fixture 102. The energy metering module 111 can include any of a number of measuring devices and related devices, including but not limited to a voltmeter, an ammeter, a power meter, an ohmmeter, a current transformer, a potential transformer, and electrical wiring. The energy metering module 111 can measure a component of power continuously, periodically, based on the occurrence of an event, based on a command received from the control module 106, and/or based on some other factor. For purposes herein, the energy metering module 111 can be considered a type of sensor (e.g., sensor module 160). In this way, a component of power measured by the energy metering module 111 can be considered a parameter herein.

In certain example embodiments, the power module 112 of the controller 104 receives power from the power supply 195 and manipulates (e.g., transforms, rectifies, inverts) that power to provide the manipulated power to one or more other components (e.g., timer 110, control engine 106) of the controller 104. Alternatively, in certain example embodiments, the power module 112 can provide power to the power supply 140 of the light fixture 102. The power module 112 can include one or more of a number of single or multiple discrete components (e.g., transistor, diode, resistor), and/or a microprocessor. The power module 112 may include a printed circuit board, upon which the microprocessor and/or one or more discrete components are positioned. In some cases, the power module 112 can include one or more components that allow the power module 112 to measure one or more elements of power (e.g., voltage, current) that is delivered to and/or sent from the power module 112.

The power module 112 can include one or more components (e.g., a transformer, a diode bridge, an inverter, a converter) that receives power (for example, through an electrical cable) from a source external to the light fixture 102 and generates power of a type (e.g., alternating current, direct current) and level (e.g., 12V, 24V, 120V) that can be used by the other components of the controller 104 and/or by the power supply 140. The power module 112 can use a closed control loop to maintain a preconfigured voltage or current with a tight tolerance at the output. The power module 112 can also protect the rest of the electronics (e.g., hardware processor 120, transceiver 124) in the light fixture 102 from surges generated in the line.

In addition, or in the alternative, the power module 112 can be a source of power in itself to provide signals to the other components of the controller 104 and/or the power supply 140. For example, the power module 112 can be a battery. As another example, the power module 112 can be a localized photovoltaic power system. The power module 112 can also have sufficient isolation in the associated components of the power module 112 (e.g., transformers, opto-couplers, current and voltage limiting devices) so that the power module 112 is certified to provide power to an intrinsically safe circuit.

In certain example embodiments, the power module 112 of the controller 104 can also provide power and/or control signals, directly or indirectly, to one or more of the sensor modules 160. In such a case, the control engine 106 can direct the power generated by the power module 112 to the sensor modules 160 of the light fixture 102. In this way, power can be conserved by sending power to the sensor modules 160 of the light fixture 102 when those devices need power, as determined by the control engine 106.

The hardware processor 120 of the controller 104 executes software, algorithms, and firmware in accordance with one or more example embodiments. Specifically, the hardware processor 120 can execute software on the control engine 106 or any other portion of the controller 104, as well as software used by the user 150, the other electrical device 180, the power source 195, and/or one or more of the sensor modules 160. The hardware processor 120 can be an integrated circuit, a central processing unit, a multi-core processing chip, SoC, a multi-chip module including multiple multi-core processing chips, or other hardware processor in one or more example embodiments. The hardware processor 120 is known by other names, including but not limited to a computer processor, a microprocessor, and a multi-core processor.

In one or more example embodiments, the hardware processor 120 executes software instructions stored in memory 122. The memory 122 includes one or more cache memories, main memory, and/or any other suitable type of memory. The memory 122 can include volatile and/or non-volatile memory. The memory 122 is discretely located within the controller 104 relative to the hardware processor 120 according to some example embodiments. In certain configurations, the memory 122 can be integrated with the hardware processor 120.

In certain example embodiments, the controller 104 does not include a hardware processor 120. In such a case, the controller 104 can include, as an example, one or more field programmable gate arrays (FPGA), one or more insulated-gate bipolar transistors (IGBTs), one or more integrated circuits (ICs). Using FPGAs, IGBTs, ICs, and/or other similar devices known in the art allows the controller 104 (or portions thereof) to be programmable and function according to certain logic rules and thresholds without the use of a hardware processor. Alternatively, FPGAs, IGBTs, ICs, and/or similar devices can be used in conjunction with one or more hardware processors 120.

The transceiver 124 of the controller 104 can send and/or receive control signals and/or communication signals (e.g., signals 197). Specifically, the transceiver 124 can be used to transfer data between the controller 104 and a user 150 (including an optional transceiver 198), the other electrical device 180, the power source 195, and/or the sensor modules 160. The transceiver 124 can use wired and/or wireless technology. The transceiver 124 can be configured in such a way that the control and/or communication signals sent and/or received by the transceiver 124 can be received and/or sent by another transceiver that is part of a user 150 (including an optional transceiver 198), the other electrical device 180, the power source 195, and/or the sensor modules 160. The transceiver 124 can use any of a number of signal types, including but not limited to RF signals (a type of communication signal 197). In some cases, the transceiver 124 can be part of, or at least be in communication with, the antenna assembly 170.

When the transceiver 124 uses wireless technology, any type of wireless technology can be used by the transceiver 124 in sending and receiving signals. Such wireless technology can include, but is not limited to, Wi-Fi, Zigbee, visible light communication, cellular networking, BLE, and Bluetooth. The transceiver 124 can use one or more of any number of suitable communication protocols (e.g., ISA100, HART) when sending and/or receiving signals. Such communication protocols can be stored in the communication protocols 132 of the storage repository 130. Further, any transceiver information for the user 150, the other electrical device 180, the power source 195, and/or the sensor modules 160 can be part of the stored data 134 (or similar areas) of the storage repository 130.

Optionally, in one or more example embodiments, the security module 128 secures interactions between the controller 104, a user 150 (including an optional transceiver 198), the other electrical device 180, the power source 195, and/or the sensor modules 160. More specifically, the security module 128 authenticates communication from software based on security keys verifying the identity of the source of the communication. For example, user software may be associated with a security key enabling the software of a user 150 (including an optional transceiver 198) to interact with the controller 104 and/or the sensor modules 160. Further, the security module 128 can restrict receipt of information, requests for information, and/or access to information in some example embodiments.

As mentioned above, aside from the controller 104 and its components, the light fixture 102 can include a power supply 140 and one or more light sources 142. The light sources 142 of the light fixture 102 are devices and/or components typically found in a light fixture to allow the light fixture 102 to operate. The light fixture 102 can have one or more of any number and/or type of light sources 142. The light sources 142 can include any of a number of components, including but not limited to a local control module, a light source, a light engine, a heat sink, an electrical conductor or electrical cable, a terminal block, a lens, a diffuser, a reflector, an air moving device, a baffle, and a dimmer. One or more of these components of the light sources 142 can be mounted on a circuit board. A light source 142 can use any type of lighting technology, including but not limited to LED, incandescent, sodium vapor, and fluorescent.

The power supply 140 of the light fixture 102 provides power to the controller 104, one or more of the light sources 142, the antenna assembly 170, one or more of the sensor modules 160, and the optional energy storage devices 179. The power supply 140 can be called by any of a number of other names, including but not limited to a driver, a LED driver, and a ballast. The power supply 140 can be substantially the same as, or different than, the power module 112 of the controller 104. For example, the power supply 140 can include one or more of a number of single or multiple discrete components (e.g., transistor, diode, resistor), and/or a microprocessor. As another example, the power supply 140 may include a printed circuit board, upon which the microprocessor and/or one or more discrete components are positioned, and/or a dimmer.

The power supply 140 can include one or more components (e.g., a transformer, a diode bridge, an inverter, a converter) that receives power (for example, through an electrical cable) from the power module 112 of the controller 104 and generates power of a type (e.g., alternating current, direct current) and level (e.g., 12V, 24V, 120V) that can be used by the light sources 142. In addition, or in the alternative, the power supply 140 can receive power from a source external to the light fixture 102. In addition, or in the alternative, the power supply 140 can be a source of power in itself. For example, the power supply 140 can be a battery, a localized photovoltaic power system, or some other source of independent power.

As stated above, the light fixture 102 can be placed in any of a number of environments. In such a case, the housing 103 of the light fixture 102 can be configured to comply with applicable standards for any of a number of environments. This compliance with applicable standards can be upheld when at least a portion of the antenna assembly 170 is integrated with the housing 103 of the light fixture 102.

FIG. 2 illustrates one embodiment of a computing device 218 that implements one or more of the various techniques described herein, and which is representative, in whole or in part, of the elements described herein pursuant to certain exemplary embodiments. Computing device 218 is one example of a computing device and is not intended to suggest any limitation as to scope of use or functionality of the computing device and/or its possible architectures. Neither should computing device 218 be interpreted as having any dependency or requirement relating to any one or combination of components illustrated in the example computing device 218.

Computing device 218 includes one or more processors or processing units 214, one or more memory/storage components 215, one or more input/output (I/O) devices 216, and a bus 217 that allows the various components and devices to communicate with one another. Bus 217 represents one or more of any of several types of bus structures, including a memory bus or memory controller, a peripheral bus, an accelerated graphics port, and a processor or local bus using any of a variety of bus architectures. Bus 217 includes wired and/or wireless buses.

Memory/storage component 215 represents one or more computer storage media. Memory/storage component 215 includes volatile media (such as random access memory (RAM)) and/or nonvolatile media (such as read only memory (ROM), flash memory, optical disks, magnetic disks, and so forth). Memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a customer, utility, or other user to enter commands and information to computing device 218, and also allow information to be presented to the customer, utility, or other user and/or other components or devices. Examples of input devices include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 is connected to a network (not shown) (e.g., a LAN, a WAN such as the Internet, cloud, or any other similar type of network) via a network interface connection (not shown) according to some exemplary embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other exemplary embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain exemplary embodiments. Further, one or more embodiments is implemented on a distributed system having one or more nodes, where each portion of the implementation (e.g., control engine 106) is located on a different node within the distributed system. In one or more embodiments, the node corresponds to a computer system. Alternatively, the node corresponds to a processor with associated physical memory in some exemplary embodiments. The node alternatively corresponds to a processor with shared memory and/or resources in some exemplary embodiments.

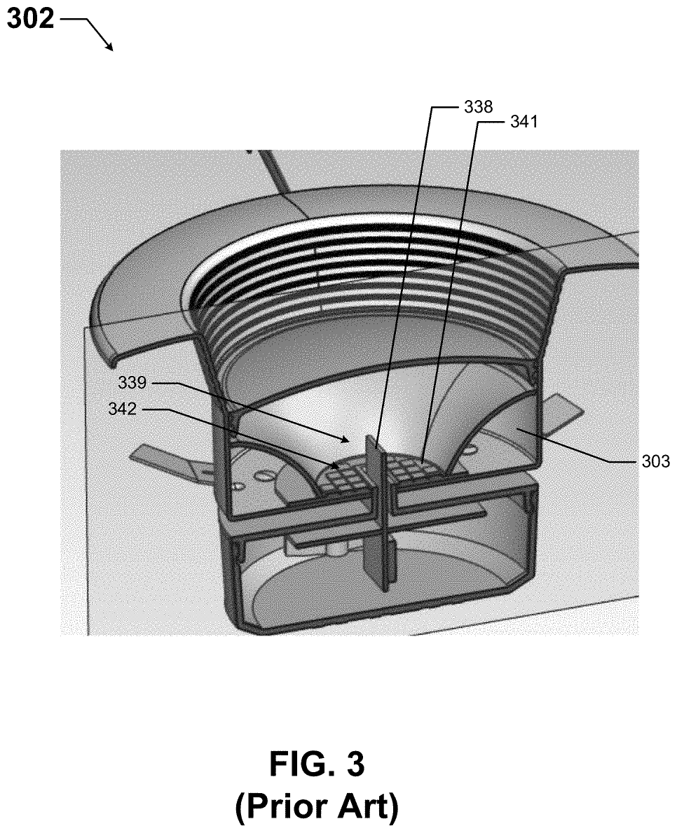

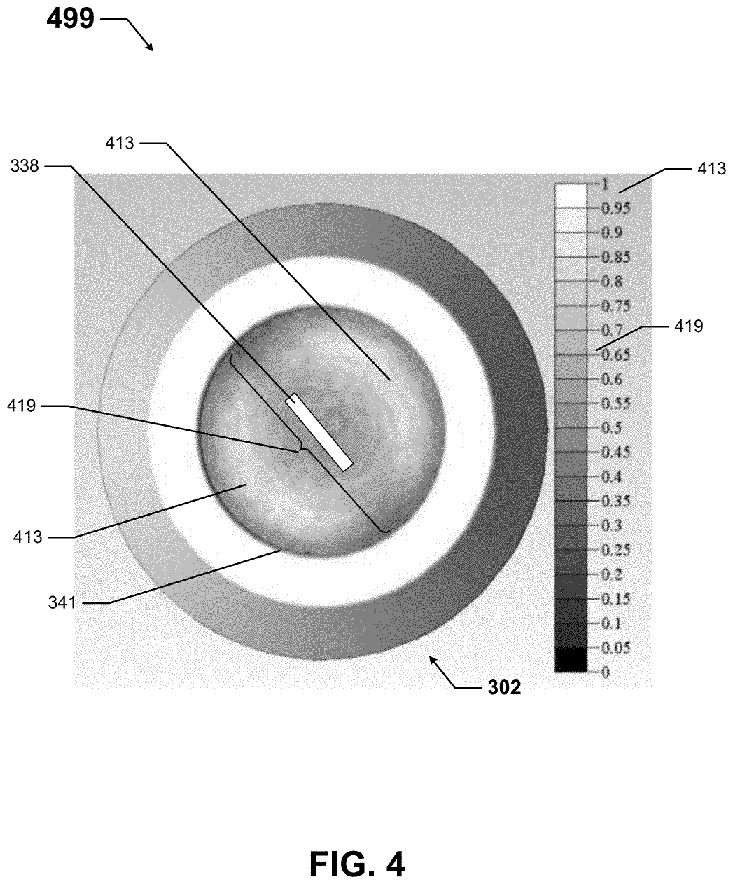

FIG. 3 shows a cross-sectional top-side perspective view of a light fixture 302 with an antenna assembly 339 currently used in the art. Referring to FIGS. 1 through 3, the light fixture 302 of FIG. 3 is a down can light fixture that includes a housing 303, multiple light sources 342, and the antenna assembly 339. The light sources 342 are mounted on a top surface of a circuit board 341. The circuit board 341 also has an aperture that traverses therethrough and in which the antenna assembly 339 is disposed. The antenna assembly 339 of FIG. 3 includes an antenna 338 that extends away from the top surface of the circuit board 341 and from the light sources 342. The distance that the antenna 338 extends from the circuit board 341 and the light sources 342 is relatively large, which creates some optical problems, as discussed below with respect to FIG. 4.

FIG. 4 shows a graph 499 of shadow effects created by the antenna assembly 339 of FIG. 3. Referring to FIGS. 1 through 4, the graph 499 of FIG. 4, which is overlaid with a bottom view of the light fixture 302, shows the shadow effects created by the antenna 338 of the antenna assembly 339. Specifically, the graph 499 shows full light 413 (no shadows) along most of the circuit board 341 and light sources (not shown in FIG. 4), except for a diagonal strip of shadow 419 (about 65% light and 35% dark) across the circuit board 341 that corresponds to the orientation and width of the antenna 338. This shadow effect caused by the antenna 338 can lead to an undesirable (or at the very least non-uniform) light distribution.

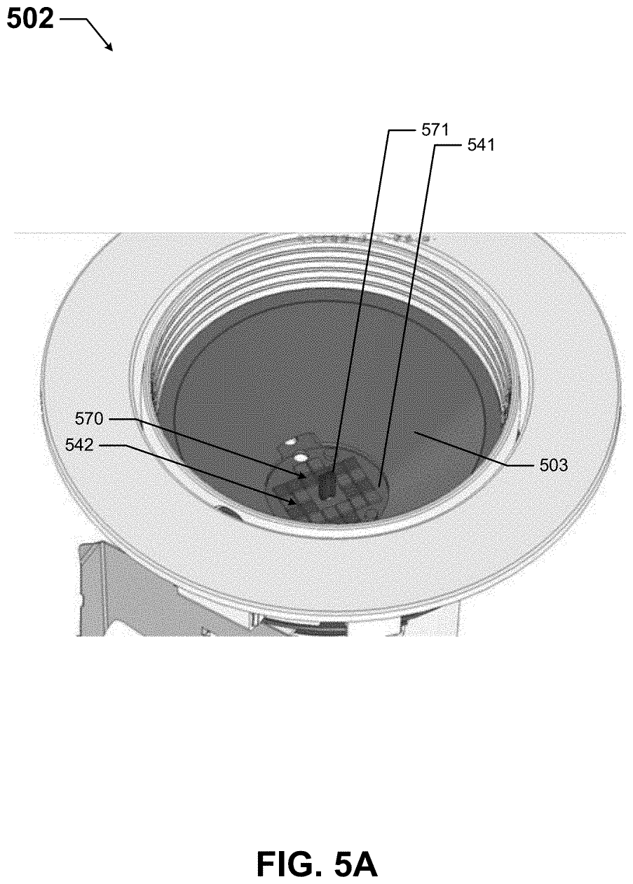

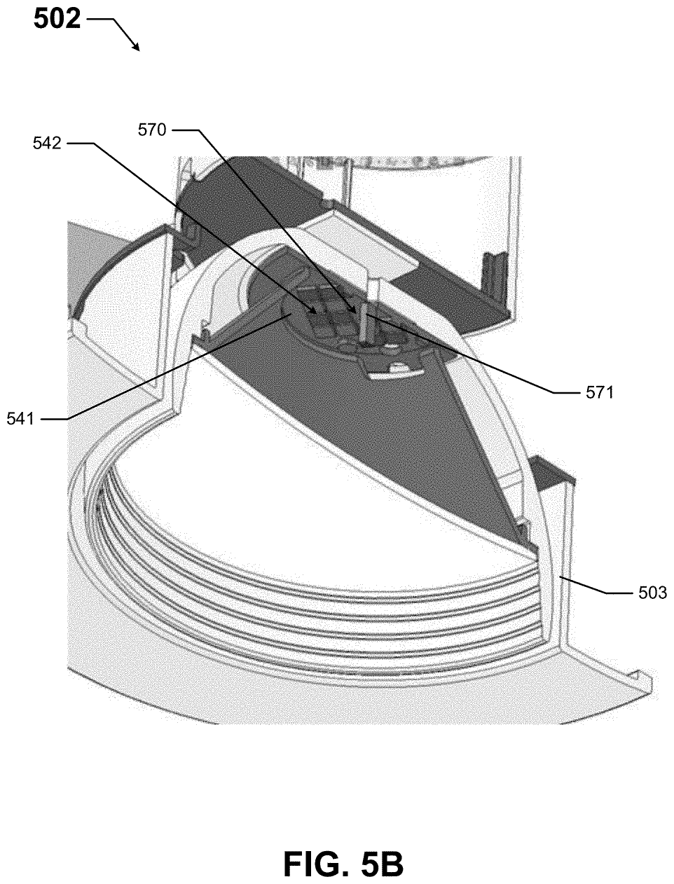

FIGS. 5A and 5B show a light fixture 502 with an antenna assembly 570 in accordance with certain example embodiments. Referring to FIGS. 1 through 5, the light fixture 502 of FIGS. 5A and 5B is a down can light fixture that includes a housing 503, multiple light sources 542, and the antenna assembly 570. The light sources 542 are mounted on a top surface of a circuit board 541. The circuit board 541 also has an aperture (hidden from view in FIGS. 5A and 5B) that traverses therethrough and in which the antenna assembly 570 is disposed. The antenna assembly 570 of FIGS. 5A and 5B includes an antenna 571 that extends away from the top surface of the circuit board 541 and from the light sources 542. The distance that the antenna 571 extends from the circuit board 541 and the light sources 542 is relatively small, which eliminates or greatly reduces optical problems caused by the antenna 571, as discussed in more detail below.

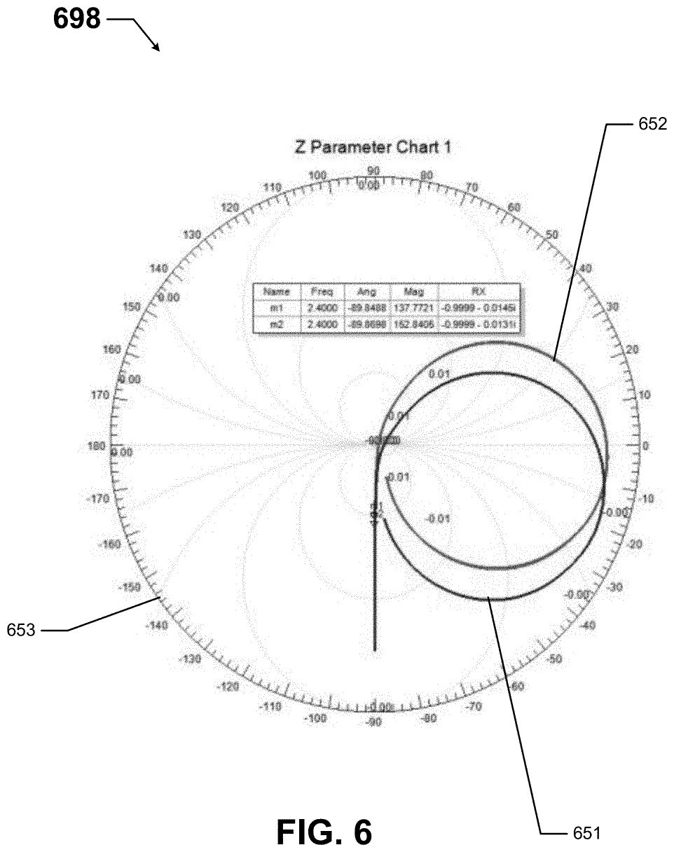

FIG. 6 shows a graph 698 of the impedance of the antenna assembly 570 of FIGS. 5A and 5B. Referring to FIGS. 1 through 6, one of the benefits of example antenna assemblies (e.g., antenna assembly 570) is that the impedance value can be adjusted to match the parasitic value, thereby greatly reducing or eliminating a negative parasitic effect on the antenna assembly 570 and/or the other circuitry (e.g., light sources 542) on the circuit board 541. The graph 698 of FIG. 6 shows how the impedance value 651 of the antenna assembly 570, after being adjusted, almost perfectly matches the parasitic value 652. The impedance value 651 and the parasitic value 652 are plotted at 2.4 GHz in terms of a magnitude at each angle 653 between −180° and +180°.

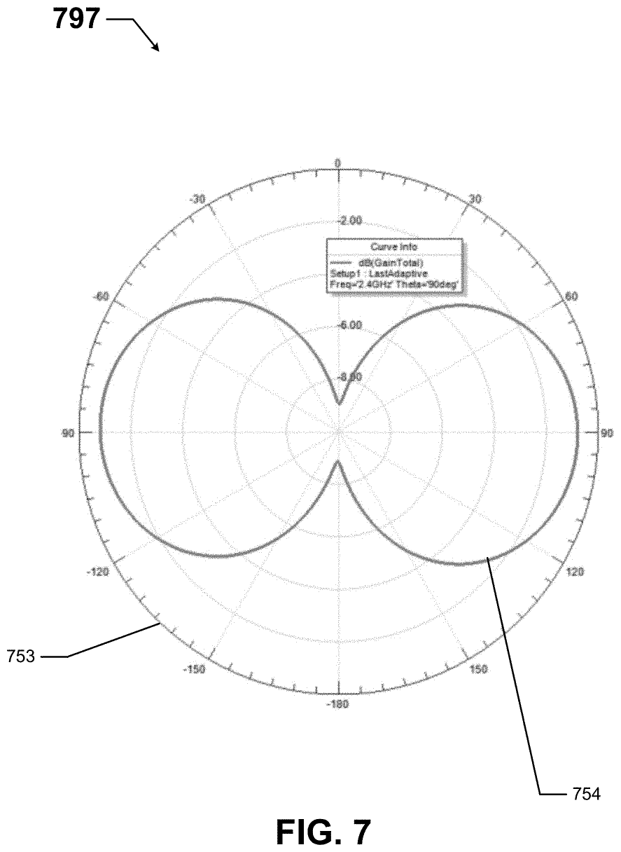

FIG. 7 shows a graph 797 of the omni-directional radiation pattern 754 for the antenna assembly 570 of FIGS. 5A and 5B. Referring to FIGS. 1 through 7, the graph 797 of FIG. 7 plots the omni-directional radiation pattern 754 in terms of gain (in dB) at 2.4 GHz at each angle 653 between −180° and +180°. The omni-directional radiation pattern 754 is symmetrical between the positive and negative angles 653, and each side of the omni-directional radiation pattern 754 is substantially circular. In this case, the directivity is approximately −0.6 dB, which is substantially omni-directional.

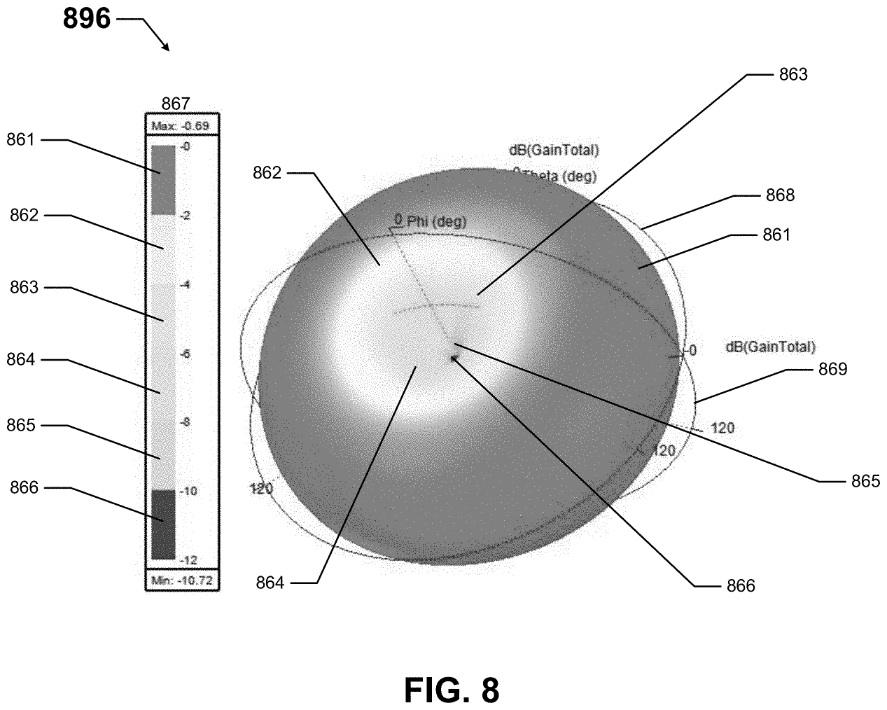

FIG. 8 shows a graph 896 of the antenna gain 867 of the antenna assembly 570 of FIGS. 5A and 5B. Referring to FIGS. 1 through 8, the graph 896 plots the antenna gain 867 in three dimensions with respect to theta angle 868 and phi angle 869. The graph 896 shows the antenna gain 867 with signals being transmitted at 2.4 GHz using the antenna assembly 570. The graph 896 shows gains 867 with a range 861 between 0 and −2 dB, a range 862 between −2 dB and −4 dB, a range 863 between −6 dB and −6 dB, a range 864 between −6 dB and −8 dB, a range 865 between −8 dB and −10 dB, and a range 866 between −10 dB and −12 dB. The gain 867 at zero theta angle 868 and zero phi angle 869 are within range 866. As the theta angle 868 and the phi angle 869 increase, the gain 867 quickly increases to range 865, then to range 864, then to range 863, then to range 862, and ending at range 861 so that most of the values for the gain 867 are within range 861. The maximum value for the gain 867 is approximately −0.4 dB.

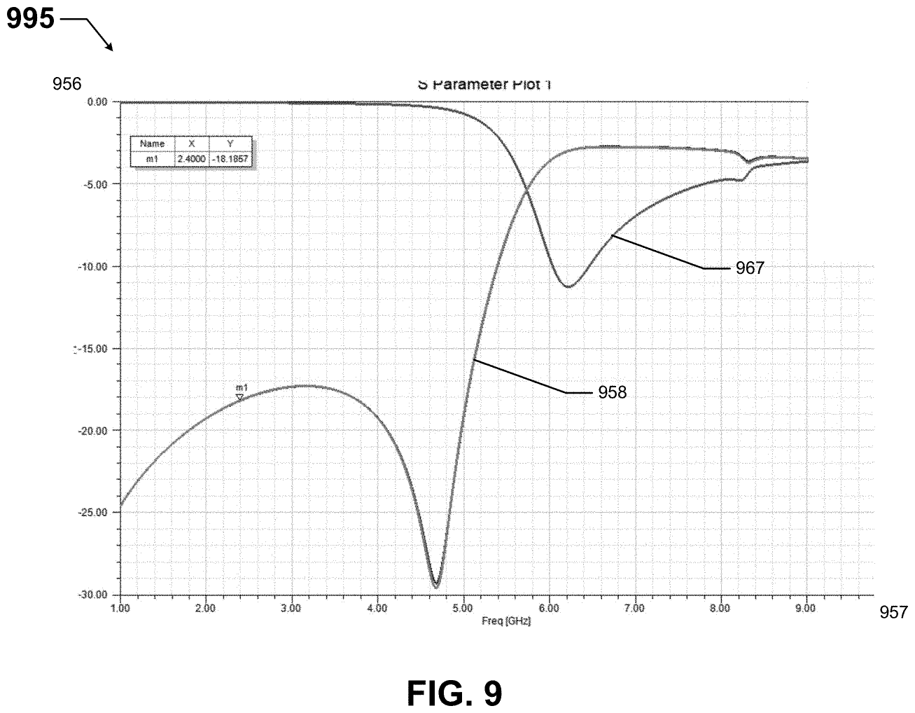

FIG. 9 shows a graph 995 of the return loss of the antenna assembly 570 of FIGS. 5A and 5B. Referring to FIGS. 1 through 9, the graph 995 of FIG. 9 plots the gain 967 of the antenna assembly 570 and the return loss 958 of the antenna assembly 570 (both in dB along the vertical axis 956) over a range of frequencies 957. At 2.4 GHz, which is used for Bluetooth and WiFi, the return loss 958 is approximately −18.2 dB while the gain 967 is approximately zero dB (e.g., −0.4 dB, as in FIG. 8). Ideally, in addition to having the gain 967 be close to zero, the return loss 958 should be larger (more negative) than −10 dB. In this way, the gain 967 and return loss 958 properties of the example antenna assembly 570 are optimal using Bluetooth or WiFi.

Similarly, using example antenna assemblies 570 with other common communication frequencies is also optimal. For example, for GSM at 900 MHz, the gain 967 is substantially zero dB, and the return loss 958 is approximately −24 dB. As another example, for GSM at 1800 MHz, the gain 967 is substantially zero dB, and the return loss 958 is approximately −20 dB. As yet another example, for WCDMA at 2.1 GHz, the gain 967 is substantially zero dB, and the return loss 958 is approximately −19 dB. In fact, it is only at very high frequencies (e.g., greater than 5.4 GHz) that the return loss 958 is greater (less negative) than −10 dB. Similarly, the gain 967 is less than (more negative) than −10 dB at frequencies that exceed 6 GHz using example antenna assemblies 570.

FIGS. 10A and 10B show a light fixture subassembly 1090 that includes an antenna assembly 1070 in accordance with certain example embodiments. Specifically, FIG. 10A shows a front-side perspective view of the light fixture subassembly 1090, and FIG. 10B shows a read-side perspective view of the light fixture subassembly 1090. Referring to FIGS. 1 through 10B, the light fixture subassembly 1090 of FIGS. 10A and 10B includes one or more light sources 1042 and an example antenna assembly 1070 coupled to a circuit board 1041. The light sources 1042, the circuit board 1041, and the antenna assembly 1070 of FIGS. 10A and 10B can be substantially the same as the corresponding components discussed above with respect to FIGS. 1 and 5A through 9. While only a single light source 1042 is shown in FIG. 10A for simplicity, multiple light sources 1042 can be disposed on the circuit board 1041.

In this case, the antenna assembly 1070 of FIGS. 10A and 10B includes a base 1072 (also sometimes called a substrate 1072) and an antenna 1071 mounted on the base 1072. The antenna 1071 and at least part of the base 1072 are disposed in an aperture 1043 that traverses the circuit board 1041. The aperture 1043 is circular in shape in this example, but in alternative embodiments, the aperture 1043 can have any of a number of other shapes (e.g., square, triangular, rectangular, octagonal, random, asymmetric).

The base 1072 of the antenna assembly 1070 in this case is a rectangular and planar segment that is coupled to the rear side of the circuit board 1041 in two places. In alternative embodiments, the base 1072 of the antenna assembly 1072 can have any of a number of substantially two-dimensional (e.g., substantially small and uniform thickness) or three-dimensional shapes (e.g., triangle, square, X-shape, Y-shape, H-shape, hexagon, random).

Also, while the base 1072 in this example makes two broad points of contact with the circuit board 1041, in alternative embodiments, the base 1072 can make three or more points of contact with the circuit board 1041. Further, while the base 1072 makes multiple contacts with the rear side of the circuit board 1041 in this example, in alternative embodiments the base 1072 can make multiple contacts with the front of the circuit board 1041 or multiple contacts with a combination of the front and the rear of the circuit board 1041.

The base 1072 can be made of one or more of any of a number of materials (e.g., FR4, Er4.4), some of which can be electrically conductive to promote the transmission of signals to and from the antenna 1071. The base 1072 can be relatively small. For example, the base 1072 of FIGS. 10A and 10B can be 7 mm long by 3.2 mm wide by 1.6 mm deep. A base with such dimensions would be approximately 4 times smaller than a base of an antenna assembly currently used in the art, such as a base of the antenna assembly 339 of FIG. 3 above.

The base 1072 can have multiple portions. For example, in this case, the base 1072 has a center portion 1076, a top portion 1073, and a bottom portion 1074, where the top portion 1073 is coupled to the circuit board 1041 at a first location adjacent to the aperture 1043 in the circuit board 1041, the bottom portion 1074 is coupled to the circuit board 1041 at a second location adjacent to the aperture 1043 in the circuit board 1041, and the center portion 1076 is disposed within the aperture 1043 in the circuit board 1041. Because of the configuration of the base 1072, the first location and the second location are opposite each other with respect to the aperture 1043 in the circuit board 1041. In alternative embodiments, depending on factors such as the shape of the base 1072 and the shape of the aperture 1041, the number of contacts between the base 1072 and the circuit board 1041 can vary as can their relative orientation around the aperture 1041.

When a portion (e.g., top portion 1073) of the base 1072 is coupled to the circuit board 1041, such coupling can be executed directly or indirectly in one or more of any of a number of ways. For example, a portion of the base 1072 can be coupled to the circuit board using solder. As another example, a portion of the base 1072 can be coupled to the circuit board using a rivet. As yet another example, a portion of the base 1072 can be coupled to the circuit board using a slot and/or a protrusion. One portion of the base 1072 can be coupled to the circuit board 1072 in the same way, or in a different way, compared to how one or more of the other portions of the base 1072 are coupled to the circuit board 1041.

The antenna 1071 of the antenna assembly 1070 of FIGS. 10A and 10B can have any of a number of configurations. For example, in this case, the antenna 1071 has a serpentine shape. As another example, the height of the antenna 1071 (i.e., the distance that the antenna 1071 extends away from the base 1072) can be small enough so as not to cast a shadow, as when there are light sources 1042 disposed on the circuit board 1041. The antenna 1071 can be made of one or more of any of a number of materials, including but not limited to metal, rubber, ceramic, and plastic.

The antenna 1071 can be coupled to the base 1072 in one or more of any number of ways. For example, the antenna 1071 can be coupled to the base 1072 using solder. As another example, the antenna 1071 can be coupled to the base 1072 using a fastening device (e.g., a screw). As yet another example, the antenna 1071 can be coupled to the base 1072 using a slot and/or a protrusion. As still another example, the antenna 1071 can be coupled to the base 1072 using an adhesive or an epoxy. In some cases, the position of the antenna 1071 can be adjusted relative to the base 1072. For example, the antenna 1071 can be rotated about an axis along the length of the antenna 1071 while coupled to the base 1072.

While the antenna assembly 1070 of FIGS. 10A and 10B has a single antenna 1071 and a single base 1072, in alternative embodiments the antenna assembly 1070 can have multiple antennae 1071 and/or multiple bases 1072. In any case, the circuit board 1041 can act as a ground when the antenna assembly 1070 is coupled to the circuit board 1041. In such a case, as the size of the circuit board increases, the performance of the antenna assembly 1070 can be further improved.

The antenna 1071 can have a relatively small clearance requirement relative to the circuit board 1041. For example, the antenna 1071 can require clearance as small as approximately 1.5 mm in all directions relative to the circuit board 1041. Since the size of the antenna 1071 is so small, this means that the aperture 1043 that traverses the circuit board 1041 and in which the antenna 1071 is disposed can also be very small.

FIGS. 11A and 11B show another light fixture subassembly 1190 that includes multiple antenna assemblies 1170 in accordance with certain example embodiments. Specifically, FIG. 11A shows a top view of the light fixture subassembly 1190, and FIG. 11B shows a rear view of the light fixture subassembly 1190. Referring to FIGS. 1 through 11B, the light fixture subassembly 1190 of FIGS. 11A and 11B includes one or more light sources 1142 and three example antenna assemblies 1170 (antenna assembly 1170-1, antenna assembly 1170-2, and antenna assembly 1170-3) coupled to a circuit board 1141. The light sources 1142, the circuit board 1141, and the antenna assemblies 1170 of FIGS. 11A and 11B can be substantially the same as the corresponding components discussed above with respect to FIGS. 1 and 5A through 10B. While only a single light source 1142 is shown in FIG. 11A for simplicity, multiple light sources 1142 can be disposed on the circuit board 1141.

In this example, antenna assembly 1170-1, antenna assembly 1170-2, and antenna assembly 1170-3 are configured substantially identically to each other. In alternative embodiments, one of the antenna assemblies 1170 can be configured differently (e.g., different shape of the antenna 1172, different size base 1172, different material of the base 1172) than one or more of the other antenna assemblies 1170. Each antenna assembly 1170 in FIGS. 11A and 11B includes a single base 1172 and a single antenna 1171 mounted on the base 1172. The antenna 1171 and at least part of the base 1172 of each antenna assembly 1170 are disposed in a separate aperture 1143 that traverses the circuit board 1141. Specifically, antenna assembly 1170-1 is positioned within aperture 1143-1, antenna assembly 1170-2 is positioned within aperture 1143-2, and antenna assembly 1170-3 is positioned within aperture 1143-3. Each aperture 1143 is circular in shape in this example.

Antenna assembly 1170-1 includes antenna 1171-1 disposed on base 1172-1, antenna assembly 1170-2 includes antenna 1171-2 disposed on base 1172-2, and antenna assembly 1170-2 includes antenna 1171-3 disposed on base 1172-3. The base 1172 of each antenna assembly 1170 in this case is a rectangular and planar segment that is coupled to the rear side of the circuit board 1141 in two locations. Also, each base 1172 in this example makes two broad points of contact with the circuit board 1141. Further, each base 1172 makes multiple contacts with the rear side of the circuit board 1141 in this example.

Each base 1172 has multiple portions. For example, in this case, base 1172-1 has a center portion 1176-1, a top portion 1173-1, and a bottom portion 1174-1, where the top portion 1173-1 is coupled to the circuit board 1141 at a first location adjacent to aperture 1143-1 in the circuit board 1141, the bottom portion 1174-1 is coupled to the circuit board 1141 at a second location adjacent to aperture 1143-1 in the circuit board 1141, and the center portion 1176-1 is disposed within aperture 1143-1 in the circuit board 1141. Base 1172-2 has a center portion 1176-2, a top portion 1173-2, and a bottom portion 1174-2, where the top portion 1173-2 is coupled to the circuit board 1141 at a first location adjacent to aperture 1143-2 in the circuit board 1141, the bottom portion 1174-2 is coupled to the circuit board 1141 at a second location adjacent to aperture 1143-2 in the circuit board 1141, and the center portion 1176-2 is disposed within aperture 1143-2 in the circuit board 1141.

Base 1172-3 has a center portion 1176-3, a top portion 1173-3, and a bottom portion 1174-3, where the top portion 1173-3 is coupled to the circuit board 1141 at a first location adjacent to aperture 1143-3 in the circuit board 1141, the bottom portion 1174-3 is coupled to the circuit board 1141 at a second location adjacent to aperture 1143-3 in the circuit board 1141, and the center portion 1176-3 is disposed within aperture 1143-3 in the circuit board 1141. Because of the configuration of each base 1172, the first location and the second location are opposite each other with respect to each aperture 1143 in the circuit board 1141.

Each antenna 1171 of an antenna assembly 1170 of FIGS. 11A and 11B can have a serpentine shape. The height of each antenna 1171 is small enough so as not to cast a shadow, as when there are light sources 1142 disposed on the circuit board 1141. Each antenna 1171 is coupled to a corresponding base 1172 in this case using solder. By having multiple antenna assemblies 1170 in this case, a single electrical device (e.g., a single light fixture) can be used not only for communication, but also for functions such as real-time location services (RTLS). For example, when used for RTLS, the multiple antenna assemblies 1170 can be used to locate an object (e.g., a beacon) in a volume of space by being able to measure a parameter (e.g., an angle or arrival, an angle of departure, a signal strength (e.g., RSSI)) of communication signals that are sent from and/or received by each antenna assembly 1170 at substantially the same time. In such a case, a controller (e.g., controller 104) can use these measured parameters, in combination with one or more algorithms (e.g., algorithm 133), to locate an object (e.g., in two dimensions, in three dimensions) in a volume of space in real time.

In one or more example embodiments, example embodiments can be integrated directly with a circuit board of a light fixture (or other electrical device). In some cases, such a circuit board can also have disposed thereon one or more other components (e.g., a light source, a sensor), the operation of which is not distorted or altered because of the configuration of example antenna assemblies. Example embodiments can be used by a local or network controller for communication purposes. One or more antenna assemblies (or portions thereof) can be disposed at locations on the light fixture to provide maximum range with little or no signal interference by the light fixture. Example embodiments can provide reliable, real-time communication capability within a volume of space without affecting light output. Example embodiments can be easily adjusted to maximize one or more characteristics (e.g., gain, impedance, directivity, return loss) associated with the example antenna assemblies. Using example embodiments described herein can improve communication, safety, maintenance, costs, and operating efficiency.

Accordingly, many modifications and other embodiments set forth herein will come to mind to one skilled in the art to which example antenna assemblies for light fixtures pertain having the benefit of the teachings presented in the foregoing descriptions and the associated drawings. Therefore, it is to be understood that integrated antenna assemblies for light fixtures are not to be limited to the specific embodiments disclosed and that modifications and other embodiments are intended to be included within the scope of this application. Although specific terms are employed herein, they are used in a generic and descriptive sense only and not for purposes of limitation.

1. A lighting device, wherein the lighting device comprises:
a first plurality of light sources;
a first circuit board on which the first plurality of light sources is mounted; and
a first antenna assembly coupled to the first circuit board, wherein the first antenna assembly comprises a first base and a first antenna mounted on the first base, wherein the first base comprises a length, a width, and a height, wherein the length is greater than the width and the width is greater than the height, wherein a surface along a plane defined by the length and the width has a first portion, a second portion, and a third portion, wherein the first antenna and the first portion of the surface of the first base are disposed within a first aperture of the first circuit board, wherein the second portion of the surface of the first base is coupled to the first circuit board at a first location, wherein the third portion of the surface of the first base is coupled to the first circuit board at a second location, and wherein the first portion, the second portion, and the third portion of the surface of the first base are oriented substantially parallel with the first circuit board.

2. The lighting device of claim 1, wherein the first base comprises an electrically conductive material.

3. The lighting device of claim 2, wherein the first base comprises solder.

4. The lighting device of claim 1, wherein the first base of the first antenna assembly comprises fiberglass.

5. The lighting device of claim 1, wherein the first antenna of the first antenna assembly comprises ceramic material.

6. (canceled)

7. The lighting device of claim 1, wherein the height is no greater than 7 mm.

8. The lighting device of claim 1, wherein the first antenna is configured in a serpentine shape.

9. The lighting device of claim 1, wherein the first antenna is separated from the first circuit board within the first aperture by a gap of at least 1 mm.

10. The lighting device of claim 1, wherein the first antenna has a gain of less than −0.5 dB at approximately 2.4 GHz.

11. The lighting device of claim 1, wherein the first antenna has an impedance value that is substantially equal to that of the first portion of the first base.

12. The lighting device of claim 11, wherein the impedance value is adjustable to match a parasitic value of the first circuit board.

13. The lighting device of claim 1, further comprising:
a second plurality of light sources;
a second circuit board on which the second plurality of light sources is mounted; and
a second antenna assembly coupled to the second circuit board, wherein the second antenna assembly comprises a second base and a second antenna mounted on the second base, wherein the second base comprises a fourth portion, a fifth portion, and a sixth portion, wherein the second antenna and the fourth portion of the second base are disposed within a second aperture of the second circuit board, wherein the fifth portion of the second base is coupled to the second circuit board at a third location, and wherein the sixth portion of the second base is coupled to the second circuit board at a fourth location.

14. The lighting device of claim 1, further comprising:
a second antenna assembly coupled to the first circuit board, wherein the second antenna assembly comprises a second base and a second antenna mounted on the second base, wherein the second base comprises a fourth portion, a fifth portion, and a sixth portion, wherein the second antenna and the fourth portion of the second base are disposed within a second aperture of the first circuit board, wherein the fifth portion of the second base is coupled to the first circuit board at a third location, and wherein the sixth portion of the second base is coupled to the first circuit board at a fourth location.

15. The lighting device of claim 1, further comprising:
a controller communicably coupled to the first antenna, wherein the controller retrieves first data from first signals received by the first antenna, and wherein the controller generates second signals having second data transmitted by the first antenna.

16. The lighting device of claim 15, wherein the controller is part of a sensor device.

17. An antenna assembly for a lighting device, the antenna assembly comprising:
a base comprising a length, a width, and a height, wherein the length is greater than the width and the width is greater than the height, wherein a surface along a plane defined by the length and the width has a first portion, a second portion, and a third portion; and
an antenna mounted on the first portion of the surface of the base so that the antenna is substantially perpendicular to and extends away from the first portion of the surface of the base, wherein the antenna and the first portion of the surface of the base are configured to be disposed within an aperture that traverses a circuit board of the lighting device, wherein the second portion of the surface of the base is configured to be coupled to the circuit board of the lighting device at a first location adjacent to the aperture, wherein the third portion of the surface of the base is configured to be coupled to the circuit board of the lighting device at a second location adjacent to the aperture, and wherein the antenna is communicably coupled to a controller of the lighting device.

18. The antenna assembly of claim 17, wherein the first portion of the surface of the base is disposed between the second portion and the third portion.

19. The antenna assembly of claim 17, wherein the surface of the base is substantially planar.

20. The antenna assembly of claim 17, wherein the base comprises a fiberglass material that is less than 2 mm thick.

21. A lighting device, wherein the lighting device comprises:
a first plurality of light sources;
a second plurality of light sources;
a first circuit board on which the first plurality of light sources is mounted;
a second circuit board on which the second plurality of light sources is mounted;
a first antenna assembly coupled to the first circuit board, wherein the first antenna assembly comprises a first base and a first antenna mounted on the first base, wherein the first base comprises a first portion, a second portion, and a third portion, wherein the first antenna and the first portion of the first base are disposed within a first aperture of the first circuit board, wherein the second portion of the first base is coupled to the first circuit board at a first location, wherein the third portion of the first base is coupled to the first circuit board at a second location, and wherein the first portion, the second portion, and the third portion of the first base are oriented substantially parallel with the first circuit board; and
a second antenna assembly coupled to the second circuit board, wherein the second antenna assembly comprises a second base and a second antenna mounted on the second base, wherein the second base comprises a fourth portion, a fifth portion, and a sixth portion, wherein the second antenna and the fourth portion of the second base are disposed within a second aperture of the second circuit board, wherein the fifth portion of the second base is coupled to the second circuit board at a third location, and wherein the sixth portion of the second base is coupled to the second circuit board at a fourth location.
